(19) United States
(12) Patent Application Publication
(10) Pub. No.: US 2013/0333442 A1
(43) Pub. Date: Dec. 19, 2013

(54) TEST SPECIMEN WITH IMPACT DETECTION MEANS

(71) Applicants: Paul-Gerhard Kibat, Frankfurt am Main (DE); Matthias Scharf, Frankfurt am Main (DE); Hanno Juhnke, Frankfurt am Main (DE); Jasmin Groeschke, Frankfurt am Main (DE); Jan-Peter Spengler, Frankfurt am Main (DE); Olaf Zeckai, Weinheim (DE)

(72) Inventors: Paul-Gerhard Kibat, Frankfurt am Main (DE); Matthias Scharf, Frankfurt am Main (DE); Hanno Juhnke, Frankfurt am Main (DE); Jasmin Groeschke, Frankfurt am Main (DE); Jan-Peter Spengler, Frankfurt am Main (DE); Olaf Zeckai, Weinheim (DE)

(73) Assignee: SANOFI-AVENTIS DEUTSCHLAND GMBH, Frankfurt am Main (DE)

(21) Appl. No.: 14/002,178

(22) PCT Filed: Mar. 15, 2012
(86) PCT No.: PCT/EP2012/054558

§ 371 Date: Aug. 29, 2013

(30) Foreign Application Priority Data
Mar. 18, 2011 (EP) 11158764.8

(51) Int. Cl. G01N 3/30

(52) U.S. Cl. CPC G01N 3/30
USPC 73/12.09

(57) ABSTRACT

The present invention relates to a test specimen for visualizing mechanical impact in a mass production process, wherein the specimen comprises of a body, at least one impact detection means at least partially covering a carrier structure of the body and adapted to visualize mechanical impact impinging on the body. A protective coating or layer covers the impact detection means entirely.

### CROSS REFERENCE TO RELATED APPLICATIONS

The present application is a U.S. National Phase Application pursuant to 35 U.S.C. §371 of International Application No. PCT/EP2012/054558 filed Mar. 15, 2012, which claims priority to European Patent Application No. 11158764.8 filed Mar. 18, 2011. The entire disclosure contents of these applications are herewith incorporated by reference into the present application.

### FIELD OF THE DISCLOSURE

The present invention relates to the field of test specimens adapted to analyze mass production processes for manufacturing and packaging, in particular for filling or bottling cartridges or similar containers with a liquid medicament.

### BACKGROUND

Particular medicaments have to be distributed and administered in liquid form which imposes strict requirements for their transportation and storage. In particular, the material such medicament containers are made from has to be inert with regard to the medicament. Typically, liquid medicaments, such like insulin or heparin are commonly stored and commercially distributed in glass containers, such like vials, carpules, ampoules, or comparable glass bottles.

Also, at least some medicaments are to be administered by way of injection. Therefore, storage containers for such medicaments may be readily designed as a cartridge having a cylindrical body or barrel sealed by means of a slidably displaceable piston. By way of the proximally located piston, distally directed pressure can be applied to the inner volume of such cartridges. Consequently, a pre-defined amount of the liquid medicament can be expelled via a distally located outlet section of the cartridge, which is typically sealed by way of a pierceable septum to be penetrated and intersected by a needle assembly, such like an injection needle.

However, cartridges or containers in general, are filled or bottled as well as packed in large numbers in a mass production process. Most cartridges, carpules, vials, ampoules or bottles intended to receive a liquid medicament are made of glass. However, in mass production processes, such containers might become subject to frequent mechanical impact, which may lead to breakage or damage of such glass containers. However, if a glass container is damaged or even entirely destroyed in a mass production process, glass splinters as well as spilled medicaments may contaminate the environment in the vicinity of the broken container. In addition container closure integrity may be substantially affected by glass breakage.

It is therefore an object of the present invention to reduce, to minimize and to prevent damaging of glass containers or cartridges in a mass production process. Preferably, the invention aims to analyze and/or to identify possible root causes for cartridge breakage or damaging in mass production processes. Moreover, the invention aims to facilitate and to enhance maintenance as well as to support adjustments on mass production manufacturing lines in general. It is a further aim to illustrate and/or to visualize mechanical impact and other factors affecting on a cartridge and/or on any other object during manufacture and/or assembly in a mass production process.

### SUMMARY

The present invention provides a test specimen for visualizing mechanical impact in a mass production and/or packaging process. For this purpose, the specimen comprises a body and at least one impact detection means which is adapted to visualize mechanical impact impinging on the body or on the test specimen during the mass production process.

In the present context, the term specimen is used for a large variety of objects to be manufactured in industrial mass production processes. Typically, the test specimen mimics the shape and geometry of impact sensitive objects, e.g. syringes, carpules, ampoules or cartridges which may be intended to be filled with a liquid medicament. Depending on the type of specimen, its body may feature any required geometry. In case of a test cartridge, the body is preferably of substantially cylindrical shape.

When designed as a test cartridge, the test specimen may resemble and mimic any type of cartridge or container adapted to receive, to store and/or to dispense a liquid substance, in particular a liquid medicament. In that sense a cartridge may comprise a bottle, an ampoule, a carpule or a vial.

Additionally, the mass production process which is to be characterized and analyzed by the test specimen according to the present invention is not restricted to the actual manufacture of the specimen itself. In the present context, the term “mass production process” may also refer to the bottling and/or filling of the specimen with a liquid substance as well as to a packaging and/or transport procedure, in which the manufactured and filled specimen are normally packed and/or transported in a packaging.

By making use of a test specimen having impact detection means, any mechanical impact above a predefined threshold can be visualized and tracked later on in order to identify potential hazards for the integrity of the specimen and its body during the mass production process.

Typically, the test specimen at least slightly differs in weight compared to an original specimen, e.g. a cartridge filled with medicament. The weight difference between a test cartridge and a real cartridge is at least 2 g, at least 5 g or even more. By making use of test specimens or test cartridges featuring a different weight compared to original and real cartridges, test cartridges can be mixed with real cartridges in the production process and may be sorted out afterwards by way of a weight-based test-specimen identification.

Moreover, the test specimen is substantially identical regarding geometry and outer dimensions compared to a real or genuine specimen. The test specimen should also mimic geometric tolerances of original specimens.

According to a preferred aspect, the body of a test specimen comprises a carrier structure, for example a tubular carrier structure, at least partially covered with the impact detection means. Typically, the carrier structure is made of a rather rigid and robust material being rather insensitive and resistant to mechanical stress, like externally applied forces, pressure or impact.

According to another preferred embodiment, the impact detection means plastically deforms in response to a mechanical impact. Preferably, the impact detection means covers or forms the outer surface of the carrier structure. The impact detection means may comprise a rather soft and plastically deformable material, which under the effect of externally applied forces, such like pressure or impact shows a respective deformation. Upon leaving the mass production line, such a deformation of the impact detection means can be detected and analyzed for detecting, tracking and allocating the cause of the mechanical deformation.

Moreover, by making use of a series of test specimens comprising different impact detection means, a wide range of forces and pressures as well as impact-effects can be monitored. Depending on the deformation properties and also depending on the thickness of the impact detection means, the magnitude of mechanical forces, pressure or impact acting on the test specimen can be at least estimated.

According to a further aspect, the impact detection means comprises an impact- or pressure-sensitive colouring agent. In this embodiment, the impact detection means does not necessarily have to exhibit plastic deformation but may locally change its colour instead. This way, any force, pressure or impact above a certain threshold leaves a visually detectable imprint on the outer surface of the test specimen.

It is of further benefit, when the impact detection means is at least partially, preferably entirely covered or coated with a protective layer or coating. Preferably, said coating or layer is substantially transparent and transmits the externally applied mechanical forces or impacts. The protective coating or layer predominately serves as a securing means and is adapted to prevent separation and distribution or loosing of mechanically treated surface portions of the impact detection means. Depending on the mechanical properties of the impact detection means, otherwise it may arise, that parts or portions thereof immobilize or get lost when becoming subject to mechanical stress.

In order to prevent contamination of the mass production line with loosened particles of the impact detection means, the protective coating or layer, typically designed as a laminated foil, serves to keep the production line clean and non-contaminated, even when a test specimen or its impact detection means becomes subject to severe damages or the like. Hence, the test specimen should leave the production line particle free and abrasion free after a force impact. Preferably, no leftovers should stay in the production line after the test specimen left the same. Otherwise, the regular production and product quality could be affected.

In a further preferred embodiment, the carrier structure comprises an aluminum hollow body. This way, the test specimen is non-transparent and may be visually identified among real specimen, typically made of glass. The aluminum hollow body may be designed as turned body or as a cast member.

It is of further benefit, when according to another embodiment the impact detection means comprises a layer of wax, which may be adhesively attached to the carrier structure. Wax or comparable material featuring similar mechanical or elastic properties may easily deform under a force- or pressure impact above a pre-defined threshold. Typically, mechanical deformation of wax is non-elastic but plastic. Once a particular surface portion of the impact detection means has been deformed, the respective deformation retains until the test specimen leaves the manufacturing line.

In an alternative embodiment, the impact detection means comprises a tubular shaped polymeric body. Typically, such a polymeric body is less prone to mechanically-induced deformations compared to a wax layer. However, by way of a polymeric body, mechanical force effects and impacts within a pre-defined impact range can be detected by a plastic deformation of a polymeric material. By making use of different materials featuring different modulus of elasticity or hardness, mechanical impact and force effects that may arise during a mass production process can be analyzed quantitatively within a large range.

Typically, the tubular shaped polymeric body is frictionally engaged with the carrier structure designed as a metal cylinder. Frictional engagement of polymeric body and carrier structure may for instance be attained by way of one or several O-rings disposed between an outside wall of the carrier structure and an inside facing wall of the polymeric body. Having a frictional engagement of polymeric body and carrier structure, a used test specimen may be refurbished by simply replacing the polymeric body.

Another type of test specimen may provide an impact- or pressure-sensitive colouring agent as impact detection means. Preferably, the colouring agent comprises dye-doped micro-capsules adapted to release a particular dye in response to a mechanical impact above a pre-defined threshold. Such micro-capsules may provide a shell-like structure and may be filled with some type of dye. Upon mechanical impact, the shell will be destroyed and the dye may be released in order to modify the colour of the respective surface section, the impact was applied to.

Test specimen supplied with dye-doped micro-capsules may also comprise a rather rigid carrier structure. The surface of the carrier structure may be roughened, e.g. by sandblasting or comparable procedures in order to enhance adhesion of dye-doped micro-capsules.

In this embodiment it is of particular benefit, when a micro-capsule-based coating of the test specimen's carrier structure is further covered or coated with a protective layer, like a laminated foil. In this way, a potential contamination of the production line with colour pigments can be effectively prevented.

Generally, the invention is not limited to a particular type of test specimen but can be universally applied to a large variety of specimens, each of which being designed for a particular application purpose. For instance, the test specimen may be designed as a cartridge, such like a carpule adapted to be filled with a liquid medicament. Also, the test specimen can be designed as medicament delivery device, such like an inhaler or a pen-type injector. By way of an appropriately designed test specimen, even a manufacturing process of a medicament delivery device can be monitored and analyzed later on.

In another aspect, the invention further relates to a method of visualizing mechanical impact on specimens in a mass production process, in particular in a respective manufacturing line. The method comprises the steps of replacing an original specimen by at least one test specimen as described above. The original specimen is for instance intended to be filled with a liquid medicament or is already filled therewith. The test specimen mimics the outer appearance of an original specimen and features an almost identical geometry. The test specimen is treated in a similar or identical way in the mass production process as original or genuine ones.

During or after processing of the test specimen in the production line, an impact detection means of the test specimen is monitored, recorded and/or analyzed in order to identify causes and respective locations in the manufacturing line that may harm the integrity or functionality of such specimens.

In a further preferred embodiment, differently configured test specimen comprising different sensitivity to external mechanical impact are used in a corresponding way as described above in order to further characterize even the magnitude of mechanical impact that may arise in a manufacturing line.

Preferably, the method is applicable with test cartridges as test specimens, that mimic the shape and geometry or genuine cartridges to be filled with a liquid substance, like a liquid medicament.

It will be further apparent to those skilled in the pertinent art that various modifications and variations can be made to the present invention without departing from the spirit and scope of the invention. Further, it is to be noted, that any reference signs used in the appended claims are not to be construed as limiting the scope of the present invention.

### BRIEF DESCRIPTION OF THE DRAWINGS

In the following, preferred embodiments of the invention will be described in greater detail be making reference to the drawings, in which:

FIG. 1 schematically illustrates a test specimen in form of a test cartridge comprising an outer wax layer for visualizing and illustrating mechanical impact that may arise in a mass production process,

FIG. 2 schematically illustrates a test cartridge comprising an outer polyacrylic sleeve,

FIG. 3 is illustrative of a test cartridge comprising dye-doped micro-capsules for visually indicating mechanical impact, and

FIG. 4 finally shows the cartridge according to FIG. 1 in cross section along A-A.

### DETAILED DESCRIPTION

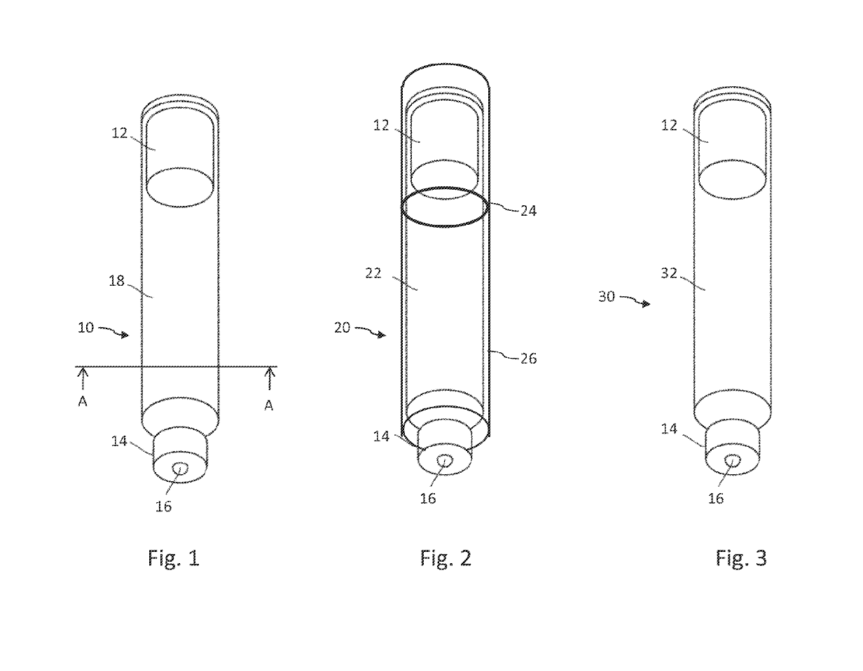

In FIGS. 1 to 3, three different embodiments of test cartridges 10, 20, 30 are schematically illustrated. In all these embodiments, the test cartridges 10, 20, 30 are illustrated with a piston or rubber stopper 12 slidably disposed in a cylindrical barrel or body 18, 22, 32. The piston 12 is only illustrative for an original cartridge, which at its distal and lower end section typically comprises a socket portion provided with a beaded cap 14 that serves to seal the distal end of the cartridge 10, 20, 30 by way of a pierceable septum 16. However, the test cartridges 10, 20, 30 are typically not provided with a displaceable piston 12 and/or with a distal seal 16, because the test specimens are not intended for use in e.g. a drug delivery device.

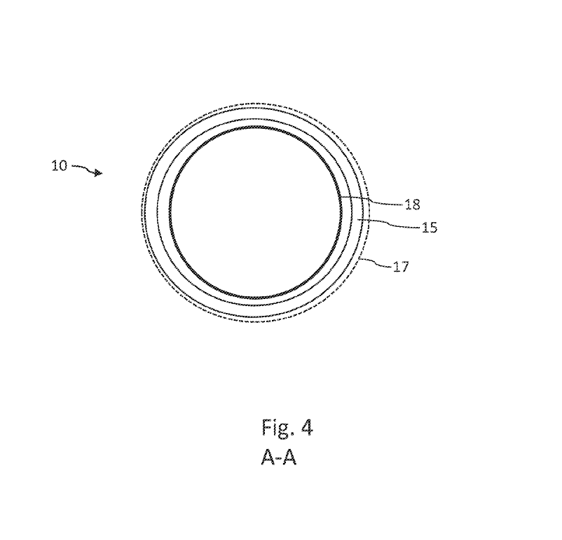

The body 18, 22, 32 of the test cartridges 10, 20, 30 typically comprises a rigid and solid carrier structure for an impact detection means 15 adapted to at least partially or even entirely cover or enclose the carrier structure. In the embodiment as illustrated in FIGS. 1 and 4, the impact detection means comprises a layer of wax 15 entirely covering the tubular carrier structure 18, which in this case is made of a hollow aluminum cylinder.

The wax layer 15 is plastically deformable in such a way, that any mechanical impact above a pre-defined threshold and impinging the cartridge 10 leaves some kind of deformation in the wax layer 15, which can be visually and/or haptically analyzed later on. The wax layer 15 is further covered or sealed with a laminated foil 17 which is intended to keep the environment of the test cartridge free of leftovers or other particles that may be loosened from the wax coating 15 in the event of a particular force- or pressure-effect.

Depending on the original thickness 15 and the hardness of the wax layer 15, even the magnitude of applied forces can be estimated from e.g. the depth and shape of impact-based deformations in or on the wax layer 15.

The embodiment according to FIG. 2 comprises a polyacrylic sleeve 26 frictionally engaged with the carrier structure 22 by way of an O-ring 24 arranged between an outer surface of the carrier structure 22 and an inside facing side wall of the polyacrylic sleeve 26. By way of the polyacrylic sleeve 26, only impacts above a pre-defined threshold can be monitored. Further, depending on the hardness of the impact detection sleeve 26, occurrence of critical mechanical impact can be detected.

Typically, the polyacrylic sleeve 26 is subject to cracking but does not disintegrate or split into several parts. Additionally, also the polyacrylic sleeve 26 can be provided with a protecting or laminated foil that intends to keep the contour of the sleeve 26 intact even in case of a severe damage.

The further embodiment as illustrated in FIG. 3 comprises a tubular carrier structure 32. By roughening the carrier 32, e.g. by way of sandblasting or the like, dye-doped micro-capsules can be adhered thereto.

By way of a layer of micro-capsules, occurrences of critical mechanical impact can be illustrated by way of a respective colouring of the area of impact. The micro-capsules are designed such, that their surrounding shell is subject to breakage when an impact above a pre-defined level impinges the cartridge 30. Also here it is generally conceivable, to make use of differently coloured micro-capsules featuring different resistance against mechanical impact. This way, even magnitude of mechanical impact could even be colour encoded.

Hence, impacts of different magnitude or different impact forces above and below certain thresholds can in general distinguished unequivocally.

Even though the illustrated embodiments exclusively refer to a cartridge, it is to be mentioned here, that the invention as defined in the appended claims is by no way limited to such cartridges in general. In particular, the features described in connection with the shown cartridges can be universally applied also to other devices, such like medicament delivery devices and/or associated packaging in general.

1-11. (canceled)

12. A test specimen for visualizing mechanical impact in a mass production process, the specimen comprises:
a body,
at least one impact detection means at least partially covering a carrier structure of the body and being adapted to visualize mechanical impact impinging on the body characterized in that the impact detection means is entirely covered with a protective coating or layer.

13. The test specimen according to claim 12, wherein the impact detection means (15) plastically deforms in response to a mechanical impact.

14. The test specimen according to claim 12, wherein the impact detection means comprises an impact- or pressure-sensitive coloring agent.

15. The test specimen according to claim 14, wherein the coloring agent comprises dye-doped micro-capsules, adapted to release a dye in response to a mechanical impact above a pre-defined threshold.

16. The test specimen according to claim 12, wherein the carrier structure comprises an aluminum hollow body.

17. The test specimen according to claim 12, wherein the impact detection means comprises a layer of wax adhesively attached to the carrier structure.

18. The test specimen according to claim 12, wherein the impact detection means comprises a tubular shaped polymeric body frictionally engaged with the carrier structure.

19. The test specimen according to claim 18, wherein the polymeric body is attached to the carrier structure by means of an O-ring disposed between an outside wall of the carrier structure and an inside facing wall of the polymeric body.

20. The test specimen according to claim 12, wherein the specimen is designed as a cartridge and/or as a medicament delivery device.

21. A method of visualizing mechanical impact on a test specimen in a mass production process, comprising the steps of:
replacing an original specimen in the production process by at least one test specimen according to any one of the preceding claims,
monitoring, recording and/or analyzing the test specimen's impact detection means during and/or after processing.

22. The method according to claim 21, further making use of differently configured test specimens, comprising different sensitivity to external mechanical impact.
